(19) United States
(12) Patent Application Publication
(10) Pub. No.: US 2017/0206277 A1
(43) Pub. Date: Jul. 20, 2017

(54) METHOD, DEVICE, AND SYSTEM FOR ENTERING AND DISPLAYING INFORMATION ABOUT A USER'S LIFE ONTO A SOCIAL MEDIA WEBSITE

(71) Applicant: Leigh M. Rothschild, Miami, FL (US)

(72) Inventor: Leigh M. Rothschild, Miami, FL (US)

(21) Appl. No.: 15/390,203

(22) Filed: Dec. 23, 2016

Related U.S. Application Data
(60) Provisional application No. 62/279,771, filed on Jan. 17, 2016.

(51) Int. Cl. G06F 17/30; H04L 29/08

(52) U.S. Cl. CPC G06F 17/30867; G06F 17/3089; H04L 67/22; H04L 51/20

(57) ABSTRACT

A system and a method for sharing a life story of a user on a social networking platform are disclosed. A life story of the user may be created using at least one format of a text, audio, image, and video. The life story may then be tagged under a category and a sub-category. The life story of the user may be accessible only to other users associated with the tagged category and the tagged sub-category. The user may perform manipulation operations on his life story. The manipulation operations may comprise adding or deleting categories and sub-categories associated with the life story, splitting the life story into multiple life stories, and linking the life story with other life stories.

### CROSS-REFERENCE TO RELATED PATENT APPLICATION

The present application is related to and claims priority of U.S. provisional patent application titled “System and method for entering and displaying information about a user's life onto a social media website,” Ser. No. 62/279,771, filed on Jan. 17, 2016. The description of the same is incorporated herein in its entirety.

### FIELD OF THE DISCLOSURE

The present disclosure is generally related to an interactive social media platform and more particularly to an online platform for sharing stories of life.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

An online social media platform acts as a gateway for people to exchange information between people. For example, Quora™ is used to discuss queries amongst users. The queries may be related to scientific, financial, political, or any other knowledge domain. Linkedin™ is another platform to explore and connect with professionals working in different domains of work at different levels. Facebook™ is another social platform for communicating amongst users. On Facebook™, users may share posts to their friends, chat with them, and thus remain connected with them.

Twitter™ is yet another social networking service used by individuals to share short messages called tweets. A registered user may share tweets that could be read and responded to by readers. Youtube™ is used for sharing videos that may be hosted by an individual or a group. Viewers can watch, share, and comment upon the videos hosted on Youtube™. Numerous other platforms exist for sharing pictures, videos, messages, locations, and experiences by individuals.

Thus, there is a need for a social media platform where a user can share his life stories and can connect with other users based on his interest in specific categories of life stories.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, a method of sharing life stories of users on a social networking platform by an algorithm running on a processor is provided. The method may comprise creating a life story of a user using at least one format of a text, audio, image, and video. The life story may be at least one of an incident occurred with the user, an observation of a real time event by the user, and any other experience by the user. The method may further comprise tagging the life story under at least one category and at least one sub-category. The life story of the user may be accessible only to other users associated with the tagged at least one category and the tagged at least one sub-category. The method may further comprise performing manipulation operations on the life story of the user. The manipulation operations may comprise adding or deleting categories and sub-categories associated with the life story, splitting the life story into multiple life stories, and linking the life story with other life stories.

In another example embodiment, a system for sharing life stories of users on a social networking platform is provided. The system may comprise one or more servers storing an algorithm thereon that, when executed by at least one processor, cause the system to share life stories of users on a social networking platform. The system may create a life story of a user using at least one format of a text, audio, image, and video. The life story may be at least one of an incident occurred with the user, an observation of a real time event by the user, and any other experience by the user. The system may further tag the life story under at least one category and at least one sub-category. The life story of the user may be accessible only to other users associated with the tagged at least one category and the tagged at least one sub-category. The system may further perform manipulation operations on the life story of the user. The manipulation operations may comprise adding or deleting categories and sub-categories associated with the life story, splitting the life story into multiple life stories, and linking the life story with other life stories.

In another example embodiment, a device for sharing life stories of users on a social networking platform is provided. The device comprises a processor and a memory coupled to the processor. The processor executes an algorithm stored in the memory to share life stories of users on a social networking platform. The device may create a life story of a user using at least one format of a text, audio, image, and video. The life story may be at least one of an incident occurred with the user, an observation of a real time event by the user, and any other experience by the user. The device may tag the life story under at least one category and at least one sub-category. The life story of the user may be accessible only to other users associated with the tagged at least one category and the tagged at least one sub-category. The device may perform manipulation operations on the life story of the user. The manipulation operations may comprise adding or deleting categories and sub-categories associated with the life story, splitting the life story into multiple life stories, and linking the life story with other life stories.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e. g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a network implementation of a system 100 for sharing life stories on a social networking platform, according to an embodiment.

FIG. 2A and FIG. 2B illustrate user interfaces of the social networking platform for sharing life stories, according to an embodiment.

FIG. 3 illustrates a flowchart 300 of a method of sharing life stories on a social networking platform, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

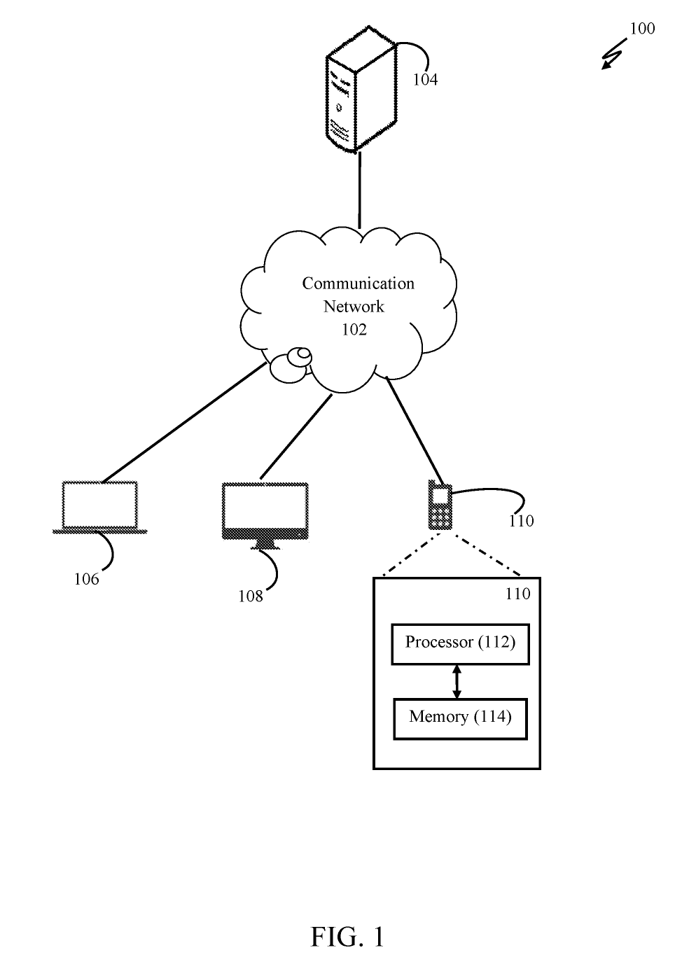

FIG. 1 illustrates a network implementation of a system 100 for sharing life stories on a social networking platform, in accordance with an embodiment of present disclosure. Several devices may be connected to a communication network 102. The communication network 102 may be implemented using at least one communication technique selected from Visible Light Communication (VLC), Worldwide Interoperability for Microwave Access (WiMAX), Long term evolution (LTE), Wireless local area network (WLAN), Infrared (IR) communication, Public Switched Telephone Network (PSTN), Radio waves, and Wireless Fidelity (Wi-Fi).

The processor 112 may execute computer program instructions stored in the memory 114. The processor 112 may also be configured to decode and execute any instructions received from one or more other electronic devices or one or more servers. The processor 112 may include one or more general purpose processors (e.g., INTEL microprocessors) and/or one or more special purpose processors (e.g., digital signal processors or Xilinx System On Chip (SOC) Field Programmable Gate Array (FPGA) processor). The processor 112 may be configured to execute one or more computer-readable program instructions, such as program instructions to carry out any of the functions described in this description.

Memory 114 may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions.

FIG. 1 illustrates a network environment of a system 100 for sharing life stories on a social networking platform, according to an embodiment. In one case, the social networking platform for sharing life stories of users may be hosted as an application on one or more servers. In an exemplary embodiment, a server 104 is shown to be hosting the social networking platform.

In one embodiment, while a new user logs onto the social networking platform for a first time, a user device may accept details from a user to create a user profile. The user device may either be a laptop 106, desktop 108, a mobile device 110, or other interactive device known in the art. Further description is provided focussing on the mobile device 110 being used, as the user device, by the user. The user may provide his personal details for creation of his profile. A user already having a profile on the social networking platform may be asked for verification of his credentials for allowing him a secure access.

In one embodiment, the user may apply privacy settings to his profile in order to set access rights for other users. The user may or may not provide access of his profile to other users. In case an open access of the user's profile is provided, other users may fetch communication details of the user to contact him. Further, other users may not be able to communicate the user while a blocked access of the user's profile is set. In one case, the user may provide partial access of his profile to the other users. During such case, the other users may only be able to come across limited details of the user.

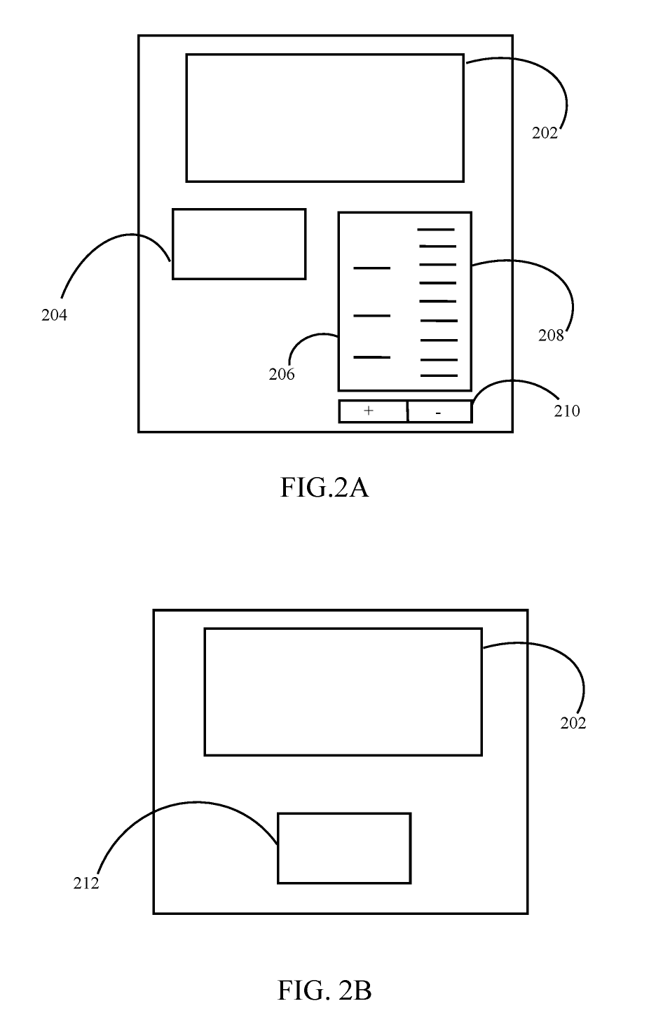

In one embodiment, the user may create a life story on a social networking platform. The life story may be an incident occurred with the user, an observation of a real time event by the user, drawings prepared by the user, an entry made by the user into his diary or journal, other experience of the user, and any event observed by the user. The life story may be created in form of a text, image, video, audio, drawing or a combination of said formats. For an example, the life story may be a video followed by a text or an audio along with an image. FIG. 2A and FIG. 2b illustrates user interface of the social networking platform. The life story may be seen in a life story window 202 illustrated in FIG. 2A and FIG. 2B.

In one embodiment, the user may tag the life story, on the social networking platform, under at least one category and at least one sub-category. The life story of the user may be accessible only to other users associated with the tagged at least one category and the tagged at least one sub-category. The at least one category and the at least one sub category may define a field of the life story. The user may select a category using a category selection window 206 and may select a sub category using a sub category selection tab 208, illustrated in user interface of FIG. 2A. For an example, history, space, medicine, pharmaceuticals, telecommunication, semiconductors, computing devices, aviation, energy resources, wars, politics, finance may be a few amongst categories defined on the social networking platform.

In an example, planets, asteroids, meteors, mars mission may be a few sub categories defined under the category space. Further, fighter planes, drones, passenger flights, chartered planes, cargo planes may be the sub categories belonging to the aviation category. The category of computing devices may comprise desktop, laptop, palmtop, netbook, tablet, phablet, and mobile phones as the sub categories. The mentioned sub categories may further comprise sub categories defined under them. For an example, the sub category of mobile phones may comprise options of different brands as the sub categories mentioned below the mobile phones.

In one embodiment, the server 104 may determine the at least one category and the at least one sub category associated with the life story. The server 104 may determine the at least one category and the at least one sub category based on the text, image, audio or video posted by the user. The server 104 may run algorithms, to process the text, image, audio or video present in the life story, for identifying the at least one category and the at least one sub category. In one case, the algorithm running on the server 104 may match the content i.e. text or image posted by the user with texts and images posted by other users in different categories and sub categories. The algorithm running on the server 104 may identify the at least one category and the at least one sub category of the matching text or the video to be relevant for the user. In one case, the server 104, running the algorithm, may suggest the first user about the at least one category and the at least one sub category associated to his life story. In another case, the server 104, running the algorithm, may add the at least one category and the at least one sub category to the life story of the user with or without suggesting to the user.

In one embodiment, the algorithm, running on the server 104, may analyse the life story of the user to identify categories of interest of the user. Based on the identified categories of interest of the user, the life story of the user may be forwarded or linked to other users having categories of interest similar to the user. For an example, a life story of the user related to Ferrari may be forwarded to the other users having sports cars as one of the category of their interest. Further, the server 104 may connect the user with another user having a category of interest matching with the life story of the user, related to Ferrari in this case.

In an embodiment, the user may be able to perform manipulation operations on his life story after tagging his story. The user may perform manipulation operations using a life story editing tab 204 illustrated in user interface of FIG. 2A. The manipulation operations may include but not limited to adding or deleting categories and sub-categories associated with the life story, splitting the life story into multiple life stories, and linking the life story with other life stories. The user may delete existing categories and sub categories and may add new categories and sub categories on the social networking platform, using a category modification tab 210. The category modification tab 210 is illustrated in user interface of FIG. 2A.

In an example, a first user may post his life story related to a category of war. The first user may post the life story under a sub category of World War 2. The first user may mention that he was a German serving as an Air Force pilot. He fought in the World War 2. The first user may also post a few images along with the text. Further, the first user may also associate the life story with sub-categories like Germany and Air force. In one case, the user may split his story into two portions, one about his service an Air Force pilot and another about his involvement in the World War 2.

In an embodiment, a second user may be interested in reading a story related to the sub category of World War 2. The second user may come across and may read the life story posted by the first user. While reading, the second user may find the life story of the first user related to a life story of the second user. For an example, the second user may also have fought in World War 2. The second user may have been an army officer and would have got his training in Germany too. The second user may link his life story with the life story of the first user. Conversely, the first user coming across the life story of the second user may link his life story with the life story of the second user.

In one embodiment, the second user may wish to connect with the first user. The second user may connect with the first user using a messaging or a video chat link provided, by the mobile device 110, on the social networking platform. The second user may collect communication details of the first user from the profile of the first user and may connect with him. The communication details may comprise a mobile number and an e-mail address.

In another example, a user may post his life story on the social networking platform. The life story may be posted under the category of space and the sub category of National Aeronautics and Space Administration (NASA) moon mission. The user may post that NASA's moon mission was a great success. He played a significant role in the moon mission. In the moon mission, the user served as a chief engineer of jet propulsion unit. In a case, the user may later add a video of his space journey to his life story.

In one embodiment, all other users may search for life stories of moon mission, on the social networking platform. The other users may be registered and may not be registered on the social networking platform. Such users may come across and may access the life story of the third user, hosted on the social networking platform. The other users may then respond to the life story using at least one of the several operations described previously.

In one embodiment, access rights may be applied to the life story of the user. The user may set the access rights using an access rights setting tab 212 illustrated in user interface of the FIG. 2B. Other users may be able to access the life story of the user based on the access rights. The access control may be set as at least one of, view entire life story, view partial life story, comment on life story, linking the life story with a similar life story, and share/forward the life story. For an example, the user may set the access rights as view entire life story only. Other users may then only be able to view the entire life story of the user, present in either of a text, audio, image, video format, or a combination of said formats.

In one embodiment, the user may apply access rights as view partial life story. In one case, the user may share his life story comprising a text portion and a video. In order to establish the view partial life story access right, the user may provide access of the text to users associated with a first set of categories and sub categories. Further, the user may provide access of the video in his life story to users associated with a second set of categories and sub categories.

In one embodiment, a software tool for editing the life stories may be present on the social networking platform. The user may access the software tool using the life story editing window 204. The software tool may be used for presenting text in different templates, editing of a video, and processing of an audio and an image. The user may use the software tool for processing his life story before posting on the social networking platform.

As mentioned above, the social networking platform may be present as a mobile application operable on the mobile device 110. The mobile application may work on mobile operating systems comprising but not limited to Android™, Windows™, and iOS™. In one case, a mobile device 110 may fetch life stories posted by users using other mobile devices present in a proximity to the mobile device 110. In another case, the mobile device 110 may present life stories of users based on interests defined by a user of the mobile device 110. The interests may either be defined in a profile of the user on the social networking platform or may be collected from a browsing history of the user.

In one embodiment, the social networking platform may provide users with a genealogy link. The genealogy link may present life stories of one or more users belonging to a family in a structured manner. In one case, a family tree may be present, comprising the users in a hierarchical manner. In case of similar life stories, links may be present between similar life stories of the users.

In one embodiment, a user having interests similar to the interests of other user, may be shared with details for communicating with the other user. In one case, the user and the other user may have undersea exploration as their interest. In such case, the user may post a life story related to the category of undersea exploration. Further, the user may create a group of other users and may provide access of the life story to the other users present in the group. The user and the other users may be allowed to chat with each other within the group. The group may comprise a messaging or chatting link for communicating with the other user. Within the group, communicated data may be unicasted, multicast, or broadcasted. Further, personal communication details of the user, such as a phone number and an e-mail address, may be shared with the other user, based on privacy settings of the user.

In an embodiment, a user may export his life story to a smart card or a smart device. The smart card or the smart device may be connected to the mobile device 110. The life story stored in the smart card or the smart device may be transferred to the mobile device 110. Further, the life story may then be transmitted to a server of an organization by the user device 110. The user may use his life story data in membership or admission applications such as hospital admittance, club admittance, or school admittance.

In one case, the user may seek admittance into a hospital. The user may transmit a portion of his life story or a portion of one of his life story to hospital's server. The life story may then be used by physicians and nurses of the hospital, attending the user. The physicians and the nurses may view the life story to know about the user. In one embodiment, the life story of the user may be shared with other users present nearby the user. The user may predefine a geographic range of the other users to be searched. The user may predefine the geographic range using the user device 110. The user may predefine the geographic range from varying from a mile to several miles. In one case, other users present within the predefined range may be suggested about the life story of the user. In another case, the life story of the user may be forwarded to the other users, present within the predefined geographic range, based on the user choice.

In one embodiment, the life stories of the other users may be analysed based on settings associated with the social networking platform. The settings may be predefined by the user for tagging the life stories to the at least one category and the at least one sub-category without requiring user intervention and analysis of the life stories.

In one embodiment, the life stories of other users may be searched by at least one of a category, word, and identity of the other users. For an example, the user may search for life stories of other users by a keyword ‘football.’ In such case, the life stories of the other users, related to football, may be retrieved and may be presented to the user. In another example, the user may search for a life story of the other user by using his name or any other personal detail.

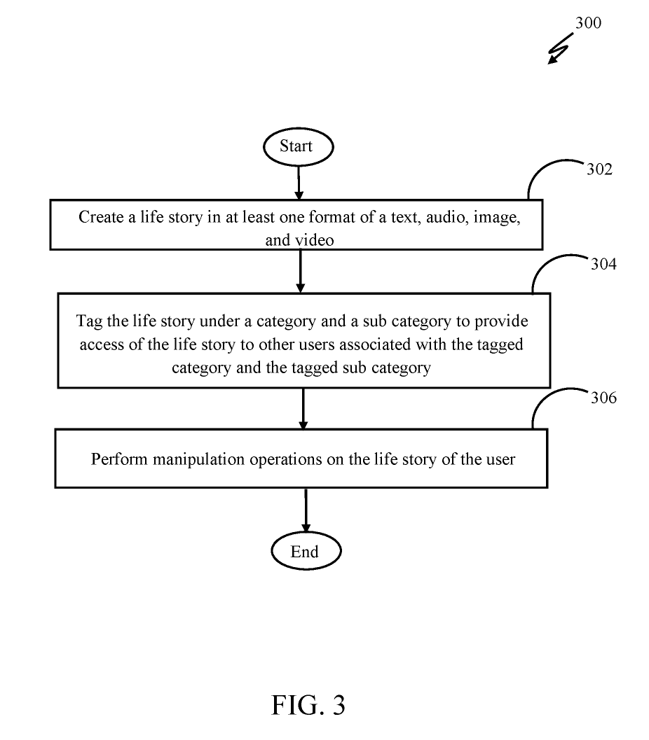

FIG. 3 illustrates a flowchart of a method of sharing life stories on a social networking platform, according to an embodiment. FIG. 3 comprises a flowchart 300 that is explained in conjunction with the elements disclosed in FIG. 1.

The flowchart 300 of FIG. 3 shows the architecture, functionality, and operation for marking objects present in an image. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 300 starts at the step 302 and proceeds to step 306.

At step 302, a life story of the user may be created. The life story may be created using at least one format of a text, audio, image, and video. The life story may be created using multiple formats selected from said formats.

At step 304, the life story of the user may be tagged under a category and a sub category. Users associated with the tagged category and the tagged sub category may only find access to the life story of the user.

At step 306, manipulation operations may be performed on the life story. The manipulation operations may be used to edit the life story. The manipulation operations may comprise editing, adding or deleting categories and sub-categories associated with the life story, splitting the life story into multiple life stories, and linking the life story with other life stories.

Embodiments of the invention can take the form of an entirely hardware embodiment or an embodiment containing both hardware and software elements. In a certain aspects, the invention is implemented using software, which includes but is not limited to firmware, resident software, microcode, and the like. Furthermore, the invention can take the form of a computer program product accessible from a computer-usable or computer-readable storage medium providing program code for use by or in connection with a computer or any instruction execution system.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e. g., a modem or network connection).

1. A method of sharing life stories of users on a social networking platform, the method being performed by an algorithm running on a processor and comprising:
creating, by the processor, a life story of a user using at least one format of a text, audio, image, and video, wherein the life story is at least one of an incident occurred with the user, an observation of a real time event by the user, and any other experience by the user;
tagging, by the processor, the life story under at least one category and at least one sub-category, wherein the life story of the user is accessible only to other users associated with the tagged at least one category and the tagged at least one sub-category; and
performing, by the processor, manipulation operations on the life story of the user, wherein the manipulation operations comprise adding or deleting categories and sub-categories associated with the life story, splitting the life story into multiple life stories, and linking the life story with other life stories.

2. The method of claim 1, wherein the at least one category and the at least one sub category is accepted as an input from the user.

3. The method of claim 1, wherein the at least one category and the at least one sub-category is determined, by the algorithm, based on matching the life story posted by the user with life stories of other users posted in different categories and sub categories.

4. The method of claim 3, wherein a content posted in the life story of the user is matched, by the algorithm, with a content posted in life stories of other users, and wherein the contents are present in at least one format of the text, audio, image, video, and drawing.

5. The method of claim 1, further comprising applying access rights to the life story of the user based on user inputs.

6. The method of claim 5, wherein the access rights may be set as at least one of, view entire life story, view partial life story, comment on life story, linking the life story with a related life story, and share/forward the life story.

7. The method of claim 1, further comprising providing a genealogy link for preparing a family tree of life stories for one or more users belonging to a family.

8. The method of claim 1, further comprising importing life story data of a user into at least one of a smart card and a smart device.

9. The method of claim 8, further comprising using the life story data, stored in the at least one of smart card and smart device, for gaining admissions and memberships in different institutions.

10. The method of claim 1, further comprising sharing life story of the user to other user present nearby within a geographic range defined by the user.

11. The method of claim 1, further comprising searching, by the algorithm, life stories of other users by at least one of a category, word, and identity of the other users.

12. The method of claim 1, further comprising analyzing life stories of the other users, based on predefined settings associated with the social networking platform to tag the life stories with the at least one category and the at least one sub-category.

13. The method of claim 1, further comprising forwarding the life story to the other users based on categories of interest of the other users.

14. The method of claim 1, further comprising connecting the user with other users based on a match between categories of interests of the other users and the life story of the user.

15. A system for sharing life stories of users on a social networking platform, the system comprising:
one or more servers storing an algorithm thereon that, when executed by at least one processor, cause the system to:
create a life story of a user using at least one format of a text, audio, image, and video, wherein the life story is at least one of an incident occurred with the user, an observation of a real time event by the user, and any other experience by the user;
tag the life story under at least one category and at least one sub-category, wherein the life story of the user is accessible only to other users associated with the tagged at least one category and the tagged at least one sub-category; and
perform manipulation operations on the life story of the user, wherein the manipulation operations comprise adding or deleting categories and sub-categories associated with the life story, splitting the life story into multiple life stories, and linking the life story with other life stories.

16. The system of claim 15, wherein the at least one category and the at least one sub-category is accepted as an input from the user.

17. The system of claim 15, wherein the at least one category and the at least one sub-category is determined, by the algorithm, based on matching the life story posted by the user with life stories of other users posted in different categories and cub categories stored on the one or more servers.

18. The system of claim 15, wherein a content posted in the life story of the user is matched, by the algorithm, with a content posted in life stories of other users, and wherein the contents are present in at least one format of the text, audio, image, video, and drawing.

19. The system of claim 15, further comprising applying access rights to the life story of the user based on user inputs.

20. The system of claim 19, wherein the access rights may be set as at least one of, view entire life story, view partial life story, comment on life story, linking the life story with a related life story, and share/forward the life story.

21. The system of claim 15, further comprising providing a genealogy link for preparing a family tree of life stories of users belonging to one family.

22. The system of claim 15, further comprising importing life story data of a user into at least one of a smart card and a smart device.

23. The system of claim 22, further comprising using the life story data, stored in the at least one of smart card and smart device, for gaining admissions and memberships in different institutions.

24. The system of claim 15, further comprising sharing life story of the user to other user present nearby within a geographic range defined by the user.

25. The system of claim 15, further comprising searching, by the algorithm, life stories of other users by at least one of a category, word, and identity of the other users.

26. The system of claim 15, further comprising modifying the instructions stored on the one or more servers for modifying a functionality of the social networking platform for sharing life stories of users.

27. The system of claim 15, further comprising analyzing life stories of the other users, based on predefined settings associated with the social networking platform to tag the life stories with the at least one category and the at least one sub-category.

28. The system of claim 15, further comprising forwarding the life story to the other users based on categories of interest of the other users.

29. The system of claim 15, further comprising connecting the user with other users based on a match between categories of interests of the other users and the life story of the user.

30. A device for sharing life stories of users on a social networking platform, the device comprising:
a processor; and
a memory coupled to the processor, wherein the processor executes an algorithm stored in the memory to:
create a life story of a user using at least one format of a text, audio, image, and video, wherein the life story is at least one of an incident occurred with the user, an observation of a real time event by the user, and any other experience by the user;
tag the life story under at least one category and at least one sub-category, wherein the life story of the user is accessible only to other users associated with the tagged at least one category and the tagged at least one sub-category; and
perform manipulation operations on the life story of the user, wherein the manipulation operations comprise adding or deleting categories and sub-categories associated with the life story, splitting the life story into multiple life stories, and linking the life story with other life stories.

31. The device of claim 30, wherein the at least one category and the at least one sub-category is accepted as an input from the user.

32. The device of claim 30, wherein the at least one category and the at least one sub-category is determined, by the algorithm, based on matching the life story posted by the user with life stories of other users posted in different categories and cub categories stored on the one or more servers.

33. The device of claim 32, wherein a content posted in the life story of the user is matched, by the algorithm, with a content posted in life stories of other users, and wherein the contents are present in at least one format of the text, audio, image, video, and drawing.

34. The device of claim 30, further comprising applying access rights to the life story of the user based on user inputs.

35. The device of claim 34, wherein the access rights may be set as at least one of, view entire life story, view partial life story, comment on life story, linking the life story with a related life story, and share/forward the life story.

36. The device of claim 30, further comprising providing a genealogy link for preparing a family tree of life stories of users belonging to one family.

37. The device of claim 30, further comprising importing life story data of a user into at least one of a smart card and a smart device.

38. The device of claim 30, further comprising sharing life story of the user to other user present nearby within a geographic range defined by the user.

39. The device of claim 30, further comprising searching, by the algorithm, life stories of other users by at least one of a category, word, and identity of the other users.

40. The device of claim 30, further comprising forwarding the life story to the other users based on categories of interest of the other users.

41. The device of claim 30, further comprising connecting the user with other users based on a match between categories of interests of the other users and the life story of the user.
